(19) United States
(12) Patent Application Publication
(10) Pub. No.: US 2012/0016775 A1
(43) Pub. Date: Jan. 19, 2012

(54) VENDOR AND SERVICE REQUEST SYSTEM AND METHOD

(76) Inventor: Gerardo Payan Ramos, El Paso, TX (US)

(21) Appl. No.: 13/186,074

(22) Filed: Jul. 19, 2011

Related U.S. Application Data
(60) Provisional application No. 61/365,552, filed on Jul. 19, 2010.
(60) Provisional application No. 61/408,947, filed on Nov. 1, 2010.

(51) Int. Cl. G06Q 30/00

(52) U.S. Cl. 705/27.1; 705/26.1

(57) ABSTRACT

A user can request various business services, products, goods, and real-time quotes from a vendor or a plurality of vendors by sending an SMS text message, or a message from an enabled-computer, to a short code text message number. In an internet-enabled or communication network-enabled interface, a user can enter the number of the mobile communication device where the user wants to receive vendor information and/or a quote for goods or services. The interface also provides the option for a user to track a part/component or tracking number for a particular good. The system provides the vendors with an alert that informs the vendor of a user request and the user's contact information. The user may be provided with a vendor's instant quote. The user can then choose to contact a vendor via text message, phone, or email or accept a vendor's offer for a good or service.

### CROSS REFERENCE TO RELATED APPLICATIONS

This patent application claims the benefit under 35 U.S.C. §119(e) of U.S. Provisional Patent Application Ser. No. 61/365,552 filed on Jul. 19, 2010, and entitled “Telemetric Engineering Marketing System and Method,” which is hereby incorporated by reference in its entirety. This patent application further claims the benefit under 35 U.S.C. §119(e) of U.S. Provisional Patent Application Ser. No. 61/408,947 filed on Nov. 1, 2010, and entitled “Telemetric Engineering Marketing System, Directory, and Search Engine,” which is hereby incorporated by reference in its entirety.

### TECHNICAL FIELD

The disclosed embodiments relate to mobile communication devices. The disclosed embodiments also relate to requesting goods and services via SMS messaging. The disclosed embodiments further relate to a vendor and user interface for real-time quotes for goods and/or services.

### BACKGROUND OF THE INVENTION

Mobile communication devices are a popular mode of communication. Today's mobile communication devices, such as cellular telephones, smartphones, wireless-enabled personal data assistants, tablet PCs, netbooks, and the like, are becoming common platforms for various software applications. These devices provide greater functionality than the ability to place and receive phone call. Numerous web-enabled capabilities are provided with these devices. A mobile communication device user now has more freedom to choose and install different software applications, thereby customizing the mobile communication device experience. Therefore, advertisers find mobile communication devices as a useful medium for advertising products and connecting with customers.

A user can be presented with advertising content or other related content on the user's mobile communication device. Often, business webpages are unreliable and contain outdated information that cannot be readily verified. The business information may be vaguely presented thus requiring a user to fill out a “Contact Us” form. Many times, a contacted vendor may take too long to follow-up on the inquiry or may not follow-up at all. An unfocused search of Yellow-Pages™-type directories may yield a fruitless search for vendors that may or may not be available to provide information to potential customers. Users want a more customized and personal experience in interacting with vendors for various goods and/or services.

Accordingly, there exists a need for an improved computer-implemented vendor request system and method where a user requests a good or service via electronic SMS messaging and is quickly provided with a return electronic message containing a choice of vendors for selection, vendor contact information, and/or competitive quotes for service.

### BRIEF SUMMARY

The following summary is provided to facilitate an understanding of some of the innovative features unique to the embodiments disclosed and is not intended to be a full description. A full appreciation of the various aspects of the embodiments can be gained by taking the entire specification, claims, drawings, and abstract as a whole.

It is therefore an object of the disclosed embodiments to provide an improved service request system and method.

It is another object of the disclosed embodiments to request goods and services via SMS messaging.

It is an additional object of the disclosed embodiments to provide a vendor and user interface for real-time quotes for goods and/or services.

The above and other aspects can be achieved as is now described. A user can request various business services, products, goods, and real-time quotes from a vendor or a plurality of vendors by sending an SMS text message, or a message from an enabled-computer, to a short code text message number. In an internet-enabled or communication network-enabled interface, a user can enter the number of the mobile communication device where the user wants to receive vendor information and/or a quote for goods or services. The interface also provides the option for a user to track a part/component or tracking number for a particular good. The system provides the vendors with an alert that informs the vendor of a user request and the user's contact information. The user may be provided with a vendor's instant quote. The user can then choose to contact a vendor via text message, phone, or email or accept a vendor's offer for a good or service.

A vendor and service request method is disclosed that comprises requesting vendor information on a mobile communication device via a request keyword and receiving real-time vendor information for selection on said mobile communication device. Requesting vendor information on a mobile communication device via a request keyword further comprises sending said request keyword to a short code SMS number wherein an associated database compares permutations of said request keyword to a keyword stored in said database and providing a suggested said request keyword. Said receiving real-time vendor information for selection on said mobile communication device comprises at least one of the following: receiving real-time quotes for a good or service via an SMS text message from a vendor, receiving said vendor's contact information, receiving said vendor's promotional material, and receiving said vendor's coupon. The method further comprises receiving said vendor information for a vendor proximately located to a user based on a zip code location of said user and receiving said vendor information for a vendor proximately located to a user based on a zip code location of a good or a service. The method can further comprise receiving vendor information results for a plurality of vendors using said request keyword and said short code for multiple said vendor information results. The method further comprises determining a location of a user via GPS location of said mobile communication device. The method can further comprise providing said vendor information for a plurality of vendors wherein a user selects a vendor from said plurality of vendors. Said vendor information can comprise at least one of the following: a service, a product, a good, package tracking, a license validation, a product validation, serial number validation, service providers, a business address, an item, a product to purchase, a payment for services, and a traffic alert.

A vendor and service request method is additionally disclose that comprises requesting vendor information on a mobile communication device via a request keyword and receiving real-time vendor information results on said mobile communication device for a plurality of vendors using said request keyword and said short code for multiple said vendor information results. Requesting vendor information on a mobile communication device via a request keyword can comprise sending said request keyword to a short code SMS number wherein an associated database compares permutations of said request keyword to a keyword stored in said database and providing a suggested said request keyword. Said receiving real-time vendor information results on said mobile communication device for a plurality of vendors using said request keyword and said short code for multiple said vendor information results can comprise at least one of the following: receiving real-time quotes for a good or service via an SMS text message from a vendor, receiving said vendor's contact information, receiving said vendor's promotional material, and receiving said vendor's coupon. The method can further comprise determining a location of a user via GPS location of said mobile communication device. Said vendor information can comprise at least one of the following: a service, a product, a good, package tracking, a license validation, a product validation, serial number validation, service providers, a business address, an item, a product to purchase, a payment for services, and a traffic alert.

A vendor and service request system is disclosed that comprises a mobile communication device for requesting vendor information via a request keyword and receiving real-time vendor information for selection on said mobile communication device. Said requesting vendor information on a mobile communication device via a request keyword can comprise sending said request keyword to a short code SMS number wherein an associated database compares permutations of said request keyword to a keyword stored in said database and said database providing a suggested said request keyword. Said receiving real-time vendor information for selection on said mobile communication device can comprise at least one of the following: receiving real-time quotes for a good or service via an SMS text message from a vendor, receiving said vendor's contact information, receiving said vendor's promotional material, and receiving said vendor's coupon. The system further comprises said vendor information received for a vendor proximately located to a user based on a zip code location of said user. The system can further comprise a plurality of vendors obtained using said request keyword and said short code for multiple said vendor information results and a user selecting a vendor from said plurality of vendors. Said vendor information can comprise at least one of the following: a service, a product, a good, package tracking, a license validation, a product validation, serial number validation, service providers, a business address, an item, a product to purchase, a payment for services, and a traffic alert.

### BRIEF DESCRIPTION OF THE DRAWINGS

The accompanying figures, in which like reference numerals refer to identical or functionally-similar elements throughout the separate views and which are incorporated in and form a part of the specification, further illustrate the embodiments and, together with the detailed description, serve to explain the embodiments disclosed herein.

FIG. 1 illustrates a schematic view of a computer system in which the present invention may be embodied;

FIG. 2 illustrates a pictorial illustration of a vendor request interface, in accordance with the disclosed embodiments;

FIG. 3 illustrates a flow chart of operations illustrating a method for requesting information from vendors, in accordance with the disclosed embodiments;

FIG. 4 illustrates a flow chart of operations illustrating a method for requesting information from vendors, in accordance with the disclosed embodiments.

FIG. 5 illustrates a flow chart of operations illustrating a method for requesting information from vendors, in accordance with the disclosed embodiments.

### DETAILED DESCRIPTION

The particular values and configurations discussed in these non-limiting examples can be varied and are cited merely to illustrate at least one embodiment and are not intended to limit the scope thereof.

The embodiments now will be described more fully hereinafter with reference to the accompanying drawings, in which illustrative embodiments of the invention are shown. The embodiments disclosed herein can be embodied in many different forms and should not be construed as limited to the embodiments set forth herein; rather, these embodiments are provided so that this disclosure will be thorough and complete, and will fully convey the scope of the invention to those skilled in the art. Like numbers refer to like elements throughout. As used herein, the term “and/or” includes any and all combinations of one or more of the associated listed items.

The terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

Unless otherwise defined, all terms (including technical and scientific terms) used herein have the same meaning as commonly understood by one of ordinary skill in the art to which this invention belongs. It will be further understood that terms, such as those defined in commonly used dictionaries, should be interpreted as having a meaning that is consistent with their meaning in the context of the relevant art and will not be interpreted in an idealized or overly formal sense unless expressly so defined herein.

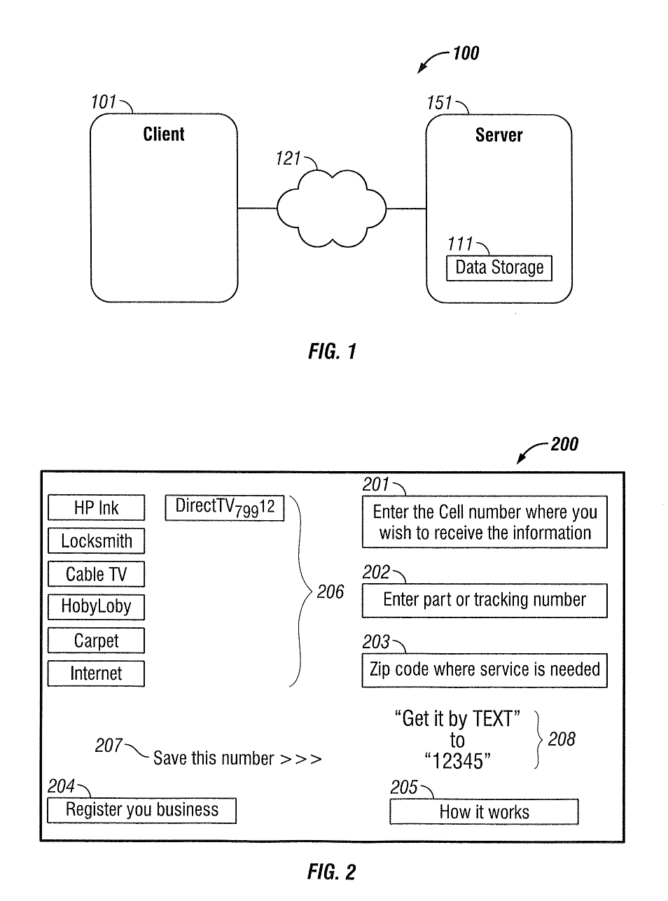

FIG. 1 illustrates a schematic view of a computer system 100 in which the present invention may be embodied. One or more servers 151 can communicate with one or more mobile communication devices 101 over a cellular, wireless Internet or other network 121. A mobile communication device 101 may also be referred to as a “mobile client device,” “client device,” “device,” or “client,” and may be referred to in the singular or plural form. The one or more servers 151 may have access to a data storage 111 that stores security information for the one or more mobile communication devices 101. Data, assessment information, information about the mobile communication devices 101, or other objects for storage may be stored on servers 151 and/or data storage 111. Servers 151 or data storage 111 may be singular or plural, or may be physical or virtualized. Data storage 111 may be a database, data table, data structure, file system or other memory store. Data storage 111 may be hosted on any of the one or more servers 151, or may exist externally from the one or more servers 151, so long as the one or more servers 151 have access to data storage 111. In an embodiment, data storage 111 is an external service provided by a third-party, such as, for example, the Simple Storage Service (S3). One will appreciate that the configuration of the system illustrated in FIG. 1 is non-limiting and merely exemplary, and that other configurations are possible without departing from this disclosure.

Communication between mobile communication device 101 and server 151 may utilize a variety of networking protocols and security measures. In an embodiment, server 151 operates as an HTTP server and the device 101 operates as an HTTP client. To secure the data in transit, mobile communication device 101 and server 151 may use Transaction Layer Security (“TLS”). Additionally, to ensure that mobile communication device 101 has authority to access server 151, and/or to verify the identity of mobile communication device 101, device 101 may send one or more identifiers or authentication credentials to server 151. For example, authentication credentials may include a user name and password, device-specific credentials, or any other data that identifies mobile communication device 101 to server 151. Authentication may allow server 151 to store information specific to mobile communication device 101 or an account associated with mobile communication device 101, to provide customized services to device 101, and to maintain a persistent view of the security status of mobile communication device 101.

In general, the following discussion includes communications between server 151 and mobile communication devices 101 over network 121. Any data transmitted or received during these communications may be stored on server 151 or on data storage 111. In an embodiment, data stored on data storage 111 or server 151 is associated with a particular account or device known to the system. The association between data and a device or account may allow server 151 to provide tailored functionality for the account or device based on previously received data. In an embodiment, server 151 will request information from a mobile communication device 101, which will respond with the requested information. In an embodiment, a mobile communication device 101 will transmit device data and/or application data to server 151 for analysis and assessment for proper vendor contact and/or real-time quote information. Server 151 will then analyze this received information in order to provide a real time directory and/or quote for services and/or vendor contact information from a vendor database. The one or more vendors may be for example, but is not limited to, a business, a plurality of businesses, a manufacturer of products, a social organization, and a service provider. One having skill in the art will appreciate that the interaction between mobile communication device 101 and server 151 can include communication from the mobile communication device 101 to the server, as well as from the vendor database and server to the mobile communication device 101. For example, in an embodiment, server 151 may receive application data from mobile communication device 101, but server 151 may require additional information before providing a real-time quote for services or transmitting the quote or other vendor information.

It should be appreciated that a disclosed embodiment can be implemented in numerous ways, including as a process, an apparatus, a system, a device, a method, a computer readable medium such as a computer readable storage medium containing computer readable instructions or computer program code, or as a computer program product comprising a computer usable medium having a computer readable program code embodied therein. A computer usable medium or computer readable medium may be any medium that can contain or store the program for use by or in connection with the instruction execution system, apparatus or device. For example, the computer readable storage medium or computer usable medium may be, but is not limited to, a random access memory (RAM), read-only memory (ROM), or a persistent store, such as a mass storage device, hard drives, CD-ROM, DVD-ROM, tape, erasable programmable read-only memory (EP-ROM or flash memory), or any magnetic, electromagnetic, infrared, optical, or electrical system, apparatus or device for storing information. Alternatively or additionally, the computer readable storage medium or computer usable medium may be any combination of these devices or even paper or another suitable medium upon which the program code is printed, as the program code can be electronically captured, via, for instance, optical scanning of the paper or other medium, then compiled, interpreted, or otherwise processed in a suitable manner, if necessary, and then stored in a computer memory.

Applications, software programs or computer readable instructions may be referred to as components or modules or data objects or data items. Applications may be hardwired or hard coded in hardware or take the form of software executing on a general purpose computer such that when the software is loaded into and/or executed by the computer, the computer becomes an apparatus for practicing the disclosure. Applications may also be downloaded in whole or in part through the use of a software development kit or toolkit that enables the creation and implementation of an embodiment of the disclosure. A user is not required to download any additional applications to implement the disclosed embodiments. The disclosed embodiments can be implemented in public telephone systems and in the keyboard box for alarm companies. One will appreciate that the mobile communication device 101 or computer-usable device described herein may include any computer or computing device running an operating system for use on handheld or mobile devices, such as smartphones, PDAs, tablets, mobile phones and the like. For example, a mobile communication device 101 may include devices such as the Apple® iPhone®, the Apple® iPad®, the Palm® Pre®, or any device running the Apple® iOS, Android® OS, Google® Chrome® OS, Symbian® OS, Windows® Mobile OS, Palm® OS or Palm Web® OS. As used herein, the mobile communication device 101 may also be referred to as a mobile device, a mobile client, or simply, as a device or as a client.

The vendor information and/or quotes for goods or services can be received on a mobile communication device 101 by means of a short message service (SMS), a multimedia message service (MMS), a Voice Message, an email, a game, a video, a screen saver, web pages loaded on the mobile communication device 101, an audio advert and a splash screen. It is also noted that in one embodiment, users may send requests for and receive responses relating to vendors in a number of different ways. A user may send a short text message via a short message service (SMS), or may access an appropriate wireless access protocol (WAP) interface. The user may also employ voicemail, send an email, or even make a regular voice phone call that is handled in an automated or a non-automated manner. The user may further send a message via a multimedia message service (MMS), among other types of ways by which a user may send requests and receive responses. Mobile communication device 101 may include, but is not limited to a cellular phone, a Personal Digital Assistant (PDA), a laptop computer, and a Smart phone.

Mobile communication device 101 can include a display screen (GUI), a keypad, a memory and a processor. The display screen can display visual/graphical icons to a user of mobile communication device 101. The user interacts with the visual/graphical icons presented on display screen by means of a positioning or input mechanism. The positioning or input mechanism may be keypad. It will be apparent to a person skilled in the art that a display screen such as, display screen of mobile communication device 101 can be a touch screen display that enables the user to interact with mobile communication device 101. A plurality of functionalities of a mobile communication device 101 can be provided to the user by a processor based on the user interaction with the visual/graphical icons. Mobile communication device 101 may operate in a communication network. The communication network may include, but is not limited to an Enhanced Data Global System for Mobile communications (GSM) network (EDGE), a Second Generation (2G) network, a Third Generation (3G) network, a Fourth Generation (4G) network, 2.75G network, a 3rd Generation Partnership Project (3GPP) network including 3GPP Long Term Evolution (LTE) network, a 3rd Generation Partnership Project 2 (3GPP2) network including 3GPP2 Ultra Mobile Broadband (UMB) network, a Wireless Fidelity (WiFi) network, or any other type of communication network.

FIG. 2 illustrates a pictorial illustration of a vendor request interface 200, in accordance with the disclosed embodiments. A user can request various business services, products, goods, real-time quotes from a vendor or a plurality of vendors by sending an SMS text message, or a message from an enabled-computer, to a short code text message number. The service functions as a “real-time” yellow pages-type directory. In an internet-enabled or communication network-enabled interface, a user can enter the number 201 of the mobile communication device 101 where the user wants to receive vendor information and/or a quote for goods or services. The interface 200 also provides the option for a user to track a part/component or tracking number for a particular good 202. A zip code where the good/service is needed 203 can be entered to provide local vendor information. A vendor can register his/her business 204 via the interface 200. A vendor can subscribe for a nominal charge to be added to a database of vendors. A Directory of Services can list vendors included in the vendor database and who are available for immediate referrals and quotes for services in a particular location. The business information can then be stored in a vendor database. Both vendors and users can learn how the system works by selecting the “How it Works” feature 205. A compiled list of often-selected vendors 206 can be presented to a user based on that particular user's vendor preferences.

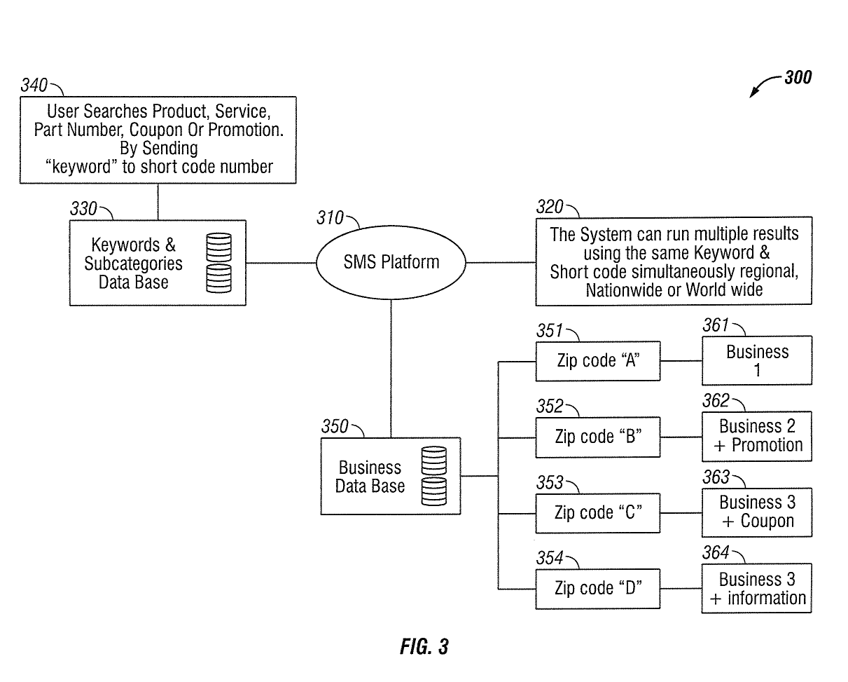

FIG. 3 illustrates a flow chart of operations illustrating a method 300 for requesting information from vendors, in accordance with the disclosed embodiments. A user searches a product, service, part number, coupon, or promotion by sending a “keyword” to a short code SMS number, as illustrated in block 340. For example, a user can begin by requesting vendor information by sending a request term describing the type of service needed, such as, for example, “locksmith”, “plumber”, “gardener”, etc. via SMS text message to the hosted service via an SMS platform, as illustrated in block 310. Next, various permutations of keywords, keyword subcategories, or translated keywords can be compared to keywords describing various business, goods, and/or services stored in a keywords and subcategories database, as illustrated in block 330. The SMS platform illustrated in block 310 then interacts with a business, or vendor, database, as illustrated in block 350. The business database in block 350 then provides vendor information and/or quotes for goods or services to a user's mobile communication device 101 via SMS text message in various zip codes or for goods or services needed in various zip codes, as illustrated in blocks 351, 352, 353, 354. From the user's mobile communication device 101, the system can recognize the location of a user and can send requests for vendors located within a specific radius of that user.

For example, in block 351, a user in zip code “A” is provided with Business 1's contact information and/or quote for a good or service, as illustrated in block 361. In block 352, a user in zip code “B” is provided with Business 2's information and/or quote for a good or service, along with Business 2's promotional information, as illustrated in block 362. In block 353, a user in zip code “C” is provided with Business 3's information and/or quote for a good or service, along with a coupon for Business 3's goods and/or services, as illustrated in block 363. In block 354, a user in zip code “D” is provided with Business 4's information and/or quote for a good or service, along with a coupon for Business 4's goods and/or services, as illustrated in block 364. As illustrated in block 320, the system can run multiple results simultaneously using the same keyword and short code (e.g., SMS message) for local, regional, national, or world-wide vendor results.

In addition to sending vendor information based on zip code location (blocks 351, 352, 353, 354), vendor information content can be sent to a mobile communication device 101 based on detection of one or more of a user activity on the mobile communication device 101, a user location and one or more alerts associated with the mobile communication device 101. The current location of the user may be determined based on triangulation or a global positioning system (GPS) with a user's mobile communication device 101. In turn, a vendor's proximate location to a user can be based triangulation or a global positioning system (GPS) with a vendor's mobile communication device 101.

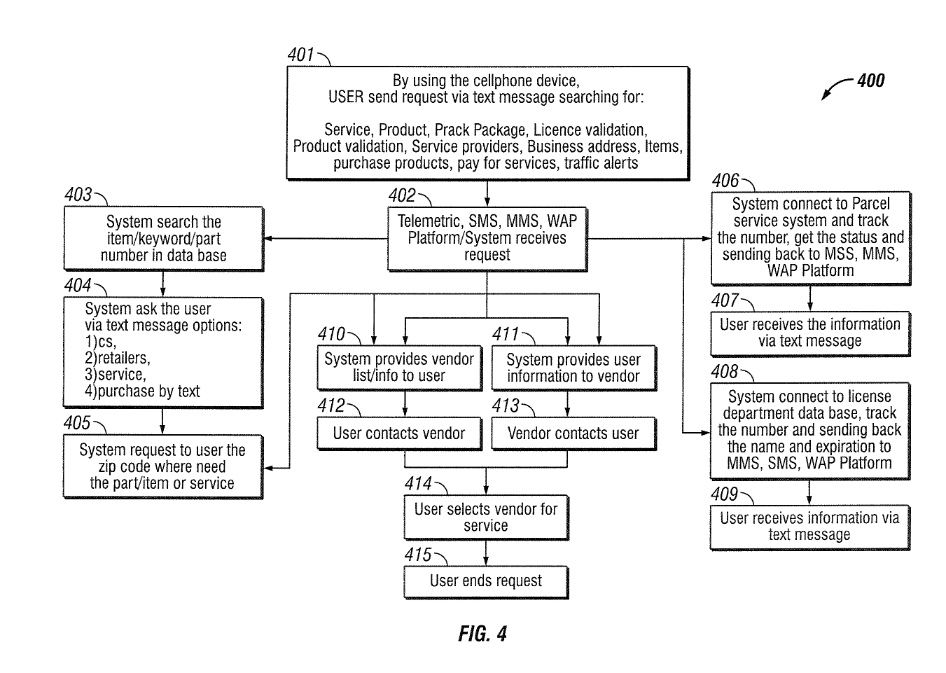

FIG. 4 illustrates a flow chart of operations illustrating a method 400 for requesting information from vendors, in accordance with the disclosed embodiments. As illustrated in block 401, by using a mobile communication device 101, a user sends a request via SMS text message searching for at least one of the following: a service, a product, a good, package tracking, a license validation, a product validation, serial number validation, service providers, a business address, an item, a product to purchase, payment for services, and traffic alerts. A telemetric SMS, MMS, WAP platform/system receives the user's request, as illustrated in block 402. The system searches the requested item, service, keyword, part number in a keyword database, as illustrated in block 403. When a system receives a request for service, a database within the system accounts for numerous permutations of the requested keyword. For example, the database could recognize the request for a locksmith service when a user texts or sends a request term of “key replacement”, “locked-out”, or other common descriptions of a service. The system then provides the user with a suggested service term based on the user's request term. The user can accept that suggested service, and will then be provided with a list of potential vendors. If the suggestion of service is incorrect, the user has the option of re-submitting the request using a different request term. The central database is also equipped to accept and process service requests in any number of languages.

The system can ask the user via text message: 1) Customer Service (i.e., “CS”), 2) Retailers, 3) Service, and 4) Purchase by Text, as illustrated in block 404. As illustrated in block 405, the system can request that the user send the zip code where the user is located or the zip code where the part/item or service is needed. The platform illustrated in block 402 can also connect to parcel service systems, track packages, obtain a package's status, and send the results back to a user via an SMS, MMS, or WAP platform, as illustrated in block 406. The user then receives this tracking and/or status information via text message as illustrated in block 407. The platform illustrated in block 402 can further connect to a license department database, track a license number or other personal identification information, and send back the license holder's name and license expiration date via an SMS, MMS, or WAP platform, as illustrated in block 408. The user then receives this tracking and/or status information via text message as illustrated in block 409.

The platform illustrated in block 402 can provide vendor information, a vendor list, or information for a plurality of vendors to a user via text message as illustrated in block 410. The system concurrently provides the subscribed vendors with an alert, either by text, email, phone, etc. informing the vendor of a user request and the user's contact information. The user may also be provided with instant service quotes by text message by vendors. Either simultaneously or consecutively, the system can provide user information to a vendor or a plurality of vendors, as illustrated in block 411. The user can then choose to contact a vendor via text message, phone, or email, as illustrated in block 412, or a vendor can contact a user, as illustrated in block 413. A subscribed vendor can contact the user who submitted the request term via text message, phone, or email to further solicit services. The user's identification information can be stored in a database to provide vendors with a list of clients for which to forward coupons and other promotional items. A user can select a vendor for service and/or to provide a good, as illustrated in block 414. If the user is not provided with quotes, a user has the option to contact a provided vendor to inquire about service fees. As illustrated in block 415, the user ends the request for vendor information once the user does one of the following: selects a particular vendor, decides to resubmit a keyword to a short code, or decides to reject all presented vendors.

For example, a user, while leaving a movie theater late at night, discovers that he locked his keys inside his car. Because he does not have access to a phone directory and does not want to invest time in a lengthy online search while standing in a dark parking lot, he chooses to text “locksmith” to a specific number, such as “12345” using his mobile communication device 101. All locksmiths registered with and subscribed to the system and within a proximate distance to the user, receive an alert to contact the user with the locksmith's contact information and/or a competitive quote for service. The vendor can respond with a personalized message or an automated message. The user can choose to contact, accept, or reject the provided locksmiths. If the user selects a locksmith to open his car, then the user can send an additional message to the system to accept a particular locksmith's offer and to stop receiving locksmith contact information. Vendors can also contact the user based on proximity, zip code entered, or GPS location of the user and/or location of the service need. The disclosed embodiments can “learn” a user's online searching and/or ordering activity to send alerts, promotions, or coupons from local merchants.

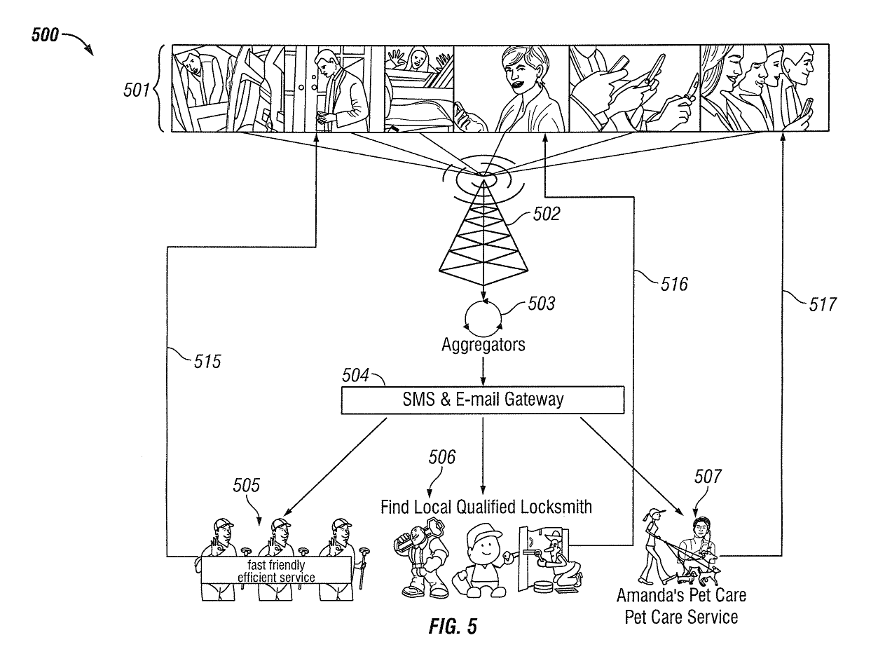

FIG. 5 illustrates a flow chart of operations illustrating a method 500 for requesting information from vendors, in accordance with the disclosed embodiments. System users 501 send a vendor request to connection aggregators 503 via wireless service providers 502. To utilize an active common short code (i.e., “CSC”), application providers and/or content providers obtain connectivity to participating wireless service providers' 502 networks. Thereafter, a message addressed to the network's CSC can be routed from the wireless network 502 to a provider's application. The system will send an alert via email or cellular text message 504 to a service provider or vendor of the product or service 505, 506, 507. The user 501 receives service and/or product information 515, 516, 517 from a vendor 505, 506, 507. The service provider or vendors 505, 506, 507 will have the option to communicate with the system users 501.

The following examples are provided to illustrate the concepts included herein. It is understood that these examples are for illustrative purposes only and are not intended as limitations of the disclosed embodiments:

### Example 1

### Track Package

Text: “tracking number”, “FedEx” or “UPS” to “Short code”

Feedback 1: Reply to the number of service

1) Customer Service→Re: Customer Service Rep will call you shortly

2) Track Package→Re: Delivery Status

### Example 2

### Search for Part or Replacement Product

HP® Printer

Send Text: “hp4500” to “short code”

Feedback 1: Office Jet 4500 All-in-One

Reply to the number of service:

1) New Printer→R: Reply Zip Code→Salesperson will contact you!—Address and phone number of retailer

2) Cartridges→R: Reply Zip Code Salesperson will contact you!—Address and phone number of retailer

3) Customer Service→R: Customer Service Rep will contact you immediately! 800-000-0000

### Example 3

### Good/Service Search

Send Text:

“Carpet” to “short code”

Feedback 1: Reply Zip Code where you want the service

Feedback 2: Reply the number for the service

1) New carpet→Re: Sales will contact you Immediately

2) Cleaning→Re: Agent will contact you Immediately

3) Repair→Re: Technician will contact you Immediately

### Example 4

### Driver's License Verification

Send license number:

“1234567” to “short code”

Feedback: Name of the person who owns the number sent

State owns the number sent

Expiration Date

It will be appreciated that variations of the above-disclosed and other features and functions, or alternatives thereof, may be desirably combined into many other different systems or applications. Also, that various presently unforeseen or unanticipated alternatives, modifications, variations or improvements therein may be subsequently made by those skilled in the art which are also intended to be encompassed by the following claims.

What is claimed is:

1. A vendor and service request method, comprising:
requesting vendor information on a mobile communication device via a request keyword; and
receiving real-time vendor information for selection on said mobile communication device.

2. The method of claim 1 wherein said requesting vendor information on said mobile communication device via said request keyword comprises:
sending said request keyword to a short code SMS number wherein an associated database compares permutations of said request keyword to a keyword stored in said database; and
providing a suggested said request keyword.

3. The method of claim 1 wherein said receiving real-time vendor information for selection on said mobile communication device comprises at least one of the following: receiving real-time quotes for a good or service via an SMS text message from a vendor, receiving said vendor's contact information, receiving said vendor's promotional material, and receiving said vendor's coupon.

4. The method of claim 1 further comprising receiving said vendor information for a vendor proximately located to a user based on a zip code location of said user.

5. The method of claim 1 further comprising receiving said vendor information for a vendor proximately located to a user based on a zip code location of a good or a service.

6. The method of claim 1 further comprising receiving vendor information results for a plurality of vendors using said request keyword and said short code for multiple said vendor information results.

7. The method of claim 1 further comprising determining a location of a user via GPS location of said mobile communication device.

8. The method of claim 1 further comprising providing said vendor information for a plurality of vendors wherein a user selects a vendor from said plurality of vendors.

9. The method of claim 1 wherein said vendor information comprises at least one of the following: a service, a product, a good, package tracking, a license validation, a product validation, serial number validation, service providers, a business address, an item, a product to purchase, a payment for services, and a traffic alert.

10. A vendor and service request method, comprising:
requesting vendor information on a mobile communication device via a request keyword; and
receiving real-time vendor information results on said mobile communication device for a plurality of vendors using said request keyword and a short code for multiple said vendor information results.

11. The method of claim 10 wherein said requesting vendor information on said mobile communication device via said request keyword comprises:
sending said request keyword to a short code SMS number wherein an associated database compares permutations of said request keyword to a keyword stored in said database; and
providing a suggested said request keyword.

12. The method of claim 10 wherein said receiving real-time vendor information results on said mobile communication device for said plurality of vendors using said request keyword and said short code for multiple said vendor information results comprises at least one of the following: receiving real-time quotes for a good or service via an SMS text message from a vendor, receiving said vendor's contact information, receiving said vendor's promotional material, and receiving said vendor's coupon.

13. The method of claim 10 further comprising determining a location of a user via GPS location of said mobile communication device.

14. The method of claim 10 wherein said vendor information comprises at least one of the following: a service, a product, a good, package tracking, a license validation, a product validation, serial number validation, service providers, a business address, an item, a product to purchase, a payment for services, and a traffic alert.

15. A vendor and service request system, comprising:
a mobile communication device for requesting vendor information via a request keyword and receiving real-time vendor information for selection on said mobile communication device.

16. The system of claim 15 wherein said requesting vendor information on said mobile communication device via a request keyword comprises:
sending said request keyword to a short code SMS number wherein an associated database compares permutations of said request keyword to a keyword stored in said database; and
said database providing a suggested said request keyword.

17. The system of claim 15 wherein said receiving real-time vendor information for selection on said mobile communication device comprises at least one of the following: receiving real-time quotes for a good or service via an SMS text message from a vendor, receiving said vendor's contact information, receiving said vendor's promotional material, and receiving said vendor's coupon.

18. The system of claim 15 further comprising said vendor information received for a vendor proximately located to a user based on a zip code location of said user.

19. The system of claim 15 further comprising:
a plurality of vendors obtained using said request keyword and a short code for multiple said vendor information results; and
a user selecting a vendor from said plurality of vendors.

20. The system of claim 15 wherein said vendor information comprises at least one of the following: a service, a product, a good, package tracking, a license validation, a product validation, serial number validation, service providers, a business address, an item, a product to purchase, a payment for services, and a traffic alert.
